(19) United States
(12) Patent Application Publication
(10) Pub. No.: US 2004/0242177 A1
(43) Pub. Date: Dec. 2, 2004

(54) Wireless LAN receiver with packet level automatic gain control

(75) Inventor: Steve S. Yang, Newark, CA (US)

Correspondence Address: C.P. Chang, c/o Pacific Law Group LLP, Suite 525, 224 Airport Parkway, San Jose, CA, 95110, US

(73) Assignee: Fodus Communications, Inc., Sunnyvale, CA

(21) Appl. No.: 10/447,810

(22) Filed: May 28, 2003

(51) Int. Cl. H04B 1/06; H04B 7/00

(52) U.S. Cl. 455/234.1; 455/245.1

(57) ABSTRACT

A Wireless LAN (WLAN) receiver with packet level Automatic Gain Control (AGC) is disclosed for receiving and converting an RF packet signal, conforming to the open standard IEEE 802.11, into recovered digital data. The receiver comprises a switchably coupled antenna, an analog signal processing circuitry for conditioning and selective frequency down-converting the RF signal into amplified, under a controllable analog gain G1A, video signals VSI and VSQ, an Analog to Digital Converter (ADC) for converting VSI and VSQ into digital outputs IADC and QADC and an AGC subsystem for effecting an adjustment of G1A and for digitally scaling, under a controllable digital gain G2D, the digital outputs LADC and QADC before final digital data recovery. The AGC subsystem further comprises a Calibration and Gain Setting firmware for measuring the preambles of each RF packet and responsively adjusting both G1A and G2D.

### GLOSSARY

APDG: Adaptive Packet Signal Detection and Gain Setting means

ADC: Analog to Digital Converter

AGC: Automatic Gain Control

ANSP: average noise signal power

ASP: analog signal processing means

BER: Bit Error Rate

CAGC: Coarse AGC means

CGS: Calibration and Gain Setting means

DAC: Digital to Analog Converter

FAGC: Fine AGC means

FBF: Frequency Bandpass Filtering means

FDC: Frequency Downward Conversion means

FGA: Fixed Gain Amplifier

IF: Intermediate Frequency

IPSP: input signal power

I/Q: In-phase/Quadrature

LAN: Local Area Network

LNA: Low Noise Amplifier

LO: Local Oscillator

LOF: Local Oscillator Frequency

NCDT: Noise Calibration and Detection Threshold Setting means

NF: Noise Figure,

NSP: noise signal power

RIN: receiver input noise

RNF: receiver noise figure

RF: Radio Frequency

RXAGC: WLAN Receiver with packet level Automatic Gain Control

SAMP: Signal Amplifying means

SCP: Switchable Coupling means

SNR: Signal-to-Noise Ratio

VGA: Variable Gain Amplifier

WLAN: Wireless Local Area Network

### FIELD OF THE INVENTION

The present invention relates generally to the field of wireless communication. More particularity, the present invention concerns the mixed-signal design architecture of a wireless LAN receiver meeting a worldwide open standard of IEEE 802.11.

### BACKGROUND OF THE INVENTION

The present invention is directed to the design architecture of a Wireless Local Area Network (WLAN) receiver operationally compatible with a worldwide open standard of IEEE802.11 comprising multiple RF (Radio Frequency) bands. The IEEE 802.11 standard specifies high-speed digital data exchange via wireless RF signal packets transmitted among numerous mobile and fixed terminals. Under IEEE 802.11, the data exchange rate is flexible and can be anywhere from 6 Mbit/sec to 54 Mbit/sec (Mega bits/sec, or 10⁶ bits/sec). In practice, the actually achievable data exchange rate is determined by the then employed data encoding scheme such as BPSK, QPSK, 8-PSK, 16-PSK, 8-QAM, 16-QAM and 64-QAM of OFDM carriers and is further limited by the noise characteristics of the delivery environment. As the distance amongst the numerous mobile and fixed terminals can vary widely on a temporal basis, the correspondingly received signal strength of the RF signal packets at the WLAN receiver will vary accordingly. Under IEEE 802.11, more than 60 dB variation of received signal strength can happen from packet to packet. It is therefore important, to maintain an optimal Signal-to-Noise Ratio (SNR) in the presence of these wide temporal signal variations thus always achieving a maximum possible data exchange rate while avoiding any possible signal over range causing a corresponding loss of signal fidelity in the analog section of the WLAN receiver, to devise a WLAN receiver having an internal signal gain that is automatically and dynamically adjustable, responsive to these signal variations, on a real-time basis.

### SUMMARY OF THE INVENTION

The first objective of this invention to achieve a WLAN receiver having an internal signal gain that is automatically and dynamically adjustable, responsive to wide and temporal incoming signal variations, on a real-time basis.

The second objective of this invention is to have such a WLAN receiver capable of adjusting its internal signal gain on a packet-by-packet basis while maintaining operational compatibility with the worldwide open standard of IEEE802.11.

Other objectives, together with the foregoing are attained in the exercise of the invention in the following description and resulting in the embodiment illustrated in the accompanying drawings.

### BRIEF DESCRIPTION OF DRAWINGS

The current invention will be better understood and the nature of the objectives set forth above will become apparent when consideration is given to the following detailed description of the preferred embodiments. For clarity of explanation, the detailed description further makes reference to the attached drawings herein:

FIG. 1 shows the WLAN receiver circuit block diagram of the present invention, having an automatically and dynamically adjustable internal signal gain responsive to incoming RF signal level variations on a real-time basis, for processing the RF signals under IEEE 802.11;

FIG. 2 is a simplified timing diagram, within a single signal packet under the IEEE 802.11, illustrating the time sequence for signal level detection and dynamic internal gain adjustment to achieve a high data exchange rate while maintaining full operational compatibility with IEEE 802.11;

FIG. 3 is a detailed, quantitative diagram illustrating the operational analog signal latitude of the key controllable analog gain elements and a corresponding operational digital signal latitude of a means for also controlling the RF signal gain in the digital domain in cooperation with the controllable analog gain elements; and

FIG. 4 and FIG. 5 are flow charts depicting the overall calibration and gain setting means including a detailed description of the means for controlling the RF signal gain in the digital domain.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessary obscuring aspects of the present invention. The detailed description is presented largely in terms of logic blocks and other symbolic representations that directly or indirectly resemble the operations of signal processing devices coupled to networks. These descriptions and representations are the means used by those experienced or skilled in the art to concisely and most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations of the invention.

As a general remark before further description of the present invention for those skilled in the art, the major elements of the analog section of an RF WLAN transceiver are amplifiers, filters, and mixers. The amplifiers are used for signal amplification. The filters are used to remove unwanted signals. The mixers are used for converting an RF signal from one frequency to another frequency for further signal filtering and amplification. The mixer is a nonlinear device. That is, during the frequency conversion process, the mixer not only generates a desired frequency but also simultaneously generates another unwanted frequency. For example, given a Local Oscillator Frequency (LOF) of fa being mixed with a signal frequency of fb during an up conversion process, the mixer generates a desired output frequency at (fa+fb) and another unwanted output frequency at (fa−fb). The output component at frequency (fa+fb), being higher than the LOF fa, is called the upper sideband, and the output component at frequency (fa−fb), being lower than the LOF fa, is called the lower sideband. A filter is thus required to remove the unwanted lower sideband. For another example, when one converts a signal at frequency fb to frequency (fa+fb), a signal at frequency (2fa+fb) also gets converted to (fa+fb) as (2fa+fb)−fb=(fa+fb). For those skilled in the art, the signal (2fa+fb) is called an image of the signal fb.

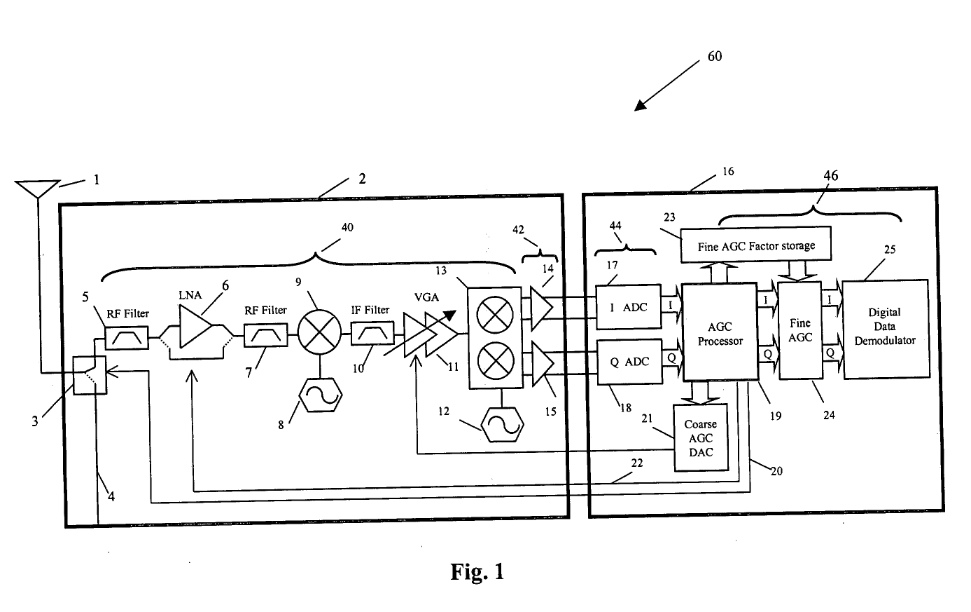

FIG. 1 shows the IEEE 802.11 WLAN receiver 60 circuit block diagram of the present invention. The IEEE 802.11 WLAN receiver 60 comprises a serially coupled set of an antenna 1, an RF analog receiver 2, an analog to digital conversion (ADC) means 44 and a digital signal processing means 46. The RF analog receiver 2 further comprises a transmitting/receiving (Tx/Rx) switch 3, an analog signal processing means 40 (ASP) and a video signal amplification means 42. The video signal amplification means 42 further comprises two parallely arranged video amplifier 14 and video amplifier 15. The Tx/Rx switch 3, being an embodiment of a Switchable Coupling means (SCP), is a controllable analog switch which switches an incoming RF signal from antenna 1 to the analog signal processing means 40 or, alternatively, switches an outgoing transmitter output signal 4 to antenna 1. As it is irrelevant to the disclosure of the present invention, the details of generation of the transmitter output signal 4 is omitted here. The analog signal processing means 40 further comprises a serially coupled set of RF filter 5, low noise amplifier (LNA) 6, RF filter 7, mixer 9 having a local oscillator (LO) 8, IF (Intermediate Frequency) filter 10, variable gain amplifier (VGA) 11 and I/Q (In-phase/Quadrature) mixers 13 having a quadrature phase LO 12. For those skilled in the art, it can be readily seen that a Frequency Bandpass Filtering means (FBF), being part of the ASP, is formed by the set of RF filter 5, RF filter 7 and IF filter 10. Similarly, a Signal Amplifying means (SAMP), being another part of the ASP, is formed by the set of LNA 6 and VGA 11. Additionally, a Frequency Downward Conversion means (FDC), being a third part of the ASP, is formed by the set of mixer 9 and I/Q mixers 13.

In operation for the receiving and selective processing of, for example, an a-band incoming RF packet channel signal under the IEEE 802.11 standard, the incoming RF packet channel signal gets collected by the antenna 1 and goes to the Tx/Rx switch 3, shown in FIG. 1 as set in a receiving state, of the RF analog receiver 2. Thus, the incoming RF packet signal passes through the Tx/Rx switch 3 to the RF filter 5. The RF filter 5 can be arranged or otherwise is pre-designed to allow the passing through of only a-band channel signal while rejecting all other off-band signal frequencies. Emerging from the RF filter 5, the a-band channel signal gets amplified by the low noise amplifier 6. The LNA 6 has a very low Noise Figure (NF) and, in this case, is designed with a gain generally in the range of 15 dB to 25 dB. Notice that, as illustrated, the LNA 6 can be switched off with a bypassing short circuit in case the strength of the incoming RF packet channel signal is above a pre-determined level to avoid saturating the LNA 6. In any case, the output channel signal of the LNA 6 is passed through another RF filter 7 to reduce an undesirable accompanying RF image signal and an undesirable image noise just amplified by the LNA 6. The thus filtered channel signal then gets down-converted into an IF signal of lower frequency by the mixer 9 working in conjunction with a pre-programmed assigned channel selection frequency generated by the LO 8. The down-converted IF signal then goes through the IF filter 10 to pass only the desired channel frequency signal while rejecting all other unwanted channel signals to achieve the best possible in-channel signal selection. The desired channel frequency signal is then further amplified again by the high VGA 11 to reach an adequate level for I/Q conversion. Usually, the VGA 11 is designed to have a more than 60 dB continuously adjustable gain control that, in combination with the switchable gain of 25 dB of the LNA 6 as described above, provides the SAMP with a total range of more than:

60 dB+25 dB=85 dB

gain control. As the just illustrated design concept is clearly not limited to the specific numbers as shown, this aspect of the present invention can be generally expressed as follows:

(a) The analog signal processing means (ASP) comprises a Signal Amplifying means (SAMP) for amplifying, with a controllable analog gain of G1A (dB), an incoming RF packet signal.

(b) The SAMP comprises a bypassable, serially coupled Fixed Gain Amplifier (FGA) with a gain of GFXD (dB) plus a serially coupled Variable Gain Amplifier (VGA) with a gain of GVAR (dB) and a continuously adjustable range of RVAR (dB) resulting in the following relationship:

G1A=GFXD+GVAR

(c) The bypassability of the FGA effects a corresponding quantized component adjustment of G1A by an amount GFXD that, in combination with the continuously component adjustable range of RVAR (dB) of the VGA, results in the following total range, RG1A, of gain adjustment for the SAMP:

RG1A=GFXD+RVAR.

After the desired channel frequency signal is further amplified by the high VGA 11 thus reaching an adequate level for I/Q conversion, the further amplified channel frequency signal gets decomposed and converted into two component video signals, respectively named in-phase video I and quadrature-phase video Q, having a quadrature phase relationship there between by the I/Q mixers 13 working in conjunction with another pre-programmed assigned channel selection frequency generated by the quadrature phase LO 12. The in-phase video I and the quadrature-phase video Q are respectively amplified into phase-separated video signals VSI and VSQ by the video amplifier 14 and the video amplifier 15 before subsequent conversion into digital signals. For best fidelity of signal processing, it is important to match the design of the video amplifier 14 and the video amplifier 15 so that the respectively amplified I and Q video signals maintain an nearly equal amplitude with a nearly quadrature phase relationship there between.

The ADC means 44 comprises two Analog to Digital Converters (ADC) 17 and ADC 18. It is preferable that these two Analog to Digital Converters (ADC) 17 and ADC 18 are parallely arranged. The digital signal processing means 46 comprises an Automatic Gain Control (AGC) processor 19, a coarse AGC means (CAGC) 21, a fine AGC means (FAGC) 24 and a fine AGC factor storage 23 and a Digital Data Demodulator 25. Each of the various elements of the digital signal processing means 46 are, of course, provided with a set of timing, control and data lines for proper interface amongst them as illustrated. Additionally, digital data input lines are provided between the ADC means 44 and the AGC processor 19 for digital data input thereto. Although not specifically illustrated, the CAGC 21 has a built-in Digital to Analog Converter (DAC) whose output, through a direct connection to a control input terminal of the VGA 11, effectuates the continuously adjustable gain control of the VGA 11 as described before. Line 20 is a digital output control line used by the AGC processor 19 to switch the Tx/Rx switch 3 between a receiving and a transmitting mode as described before. Line 22 is another digital output control line used by the AGC processor 19 to switch off the LNA 6 via a bypassing short circuit scheme as described before. For clarity of subsequent disclosure, an AGC means is defined as the subsystem formed by the AGC processor 19, the CAGC 21, the fine AGC factor storage 23 and the FAGC 24.

The in-phase video I and the quadrature-phase video Q are amplified by the video amplifier 14 and the video amplifier 15 before further processing. The respectively amplified video I and Q from the video amplifier 14 and the video amplifier 15 of the RF analog receiver 2 are now converted into I channel and Q channel digital data, for subsequent input and processing by the AGC means, by the ADC 17 and the ADC 18. To cover the required signal dynamic range under IEEE 802.11, both of the ADC 17 and the ADC 18 are designed as a 10-bit ADC handling differential input signals of an effective 9-bit magnitude plus a sign-bit. Thus, based upon the collected stream of I channel and Q channel digital data and a control algorithm named Calibration and Gain Setting means (CGS) being an integral part of the AGC means, the AGC means will, on a packet-by-packet basis, make dynamic decision to adjust the controllable analog gain G1A of the SAMP to maintain an optimal G1A for highly accurate data detection irrespective of wide and temporal incoming signal variations. The details of the CGS will be presently described. Anyhow, after an associated digital signal processing and a decision is made by the AGC means, it will firstly effect a coarse adjustment of the G1A through at least one of the following actions:

(a) Changing the bypassing state of the LNA 6 through line 22.

(b) Adjusting the gain GVAR of the VGA 11 via the CAGC.

Secondly, if a finer tuning of the gain G1A is still required for an optimal result, the AGC means will further calculate a fine digital gain called G2D (dB) that is stored under the fine AGC factor storage 23. The fine digital gain G2D (dB) is then used by the FAGC 24 to further scale the above I channel and Q channel digital data into a final set of digital signals DSI and DSQ before sending them to the Digital Data Demodulator 25 for a final digital data recovery. Therefore, the IEEE 802.11 WLAN receiver 60, as described, exhibits a dynamically adjustable overall system signal gain of G1A+G2D (dB) between an incoming RF packet signal and each of the digital signals DSI and DSQ.

The AGC means provides the following two major functions:

(A) Internal noise calibration and detection threshold setting.

(B) Packet signal detection and gain setting.

The AGC means accomplishes these functions, to be presently described in detail, by controlling its various hardware components with the Calibration and Gain Setting means (CGS), which, in practice, can be implemented as a hardware circuitry, a firmware or any combination thereof within the AGC processor 19.

(A) Internal noise calibration and detection threshold setting.

Reference is still made to FIG. 1. To achieve the objective of dynamically adjusting the overall system signal gain of G1A+G2D (dB) on a packet-by-packet basis while maintaining operational compatibility with the IEEE802.11, only a minimum amount of time and control steps are available within a packet time frame. Therefore, the AGC means is required to know exactly what steps to take and how much gain adjustment to effect at each step along the way while avoiding the traditional approach of close-loop iteration with cut and try that will necessarily be too slow. For this reason, the AGC means must perform an internal noise calibration and detection threshold setting before initiating the ultimate function of adjusting the overall system signal gain. During the calibration of this inherent noise internal to the IEEE 802.11 WLAN receiver 60 itself, the WLAN receiver must not be subjecting to any external signal from the antenna 1. Therefore, while insuring that the transmitter function is totally deactivated, the Tx/Rx switch 3 is switched to the side connecting the transmitter output signal 4. Meanwhile, the CGS removes the bypassing of LNA 6 via line 22, sets the VGA 11 at full gain via the CAGC 21 and concurrently samples and measures the noise level via the two digital outputs, respectively named IADC and QADC, from the 10-bit ADC 17 and ADC 18. For convenience, the following is defined for digital representation of IADC and QADC:

MSB means “Most Significant Bit”,

LSB means “Least Significant Bit”,

Bit-10=sign bit,

Bit-9=MSB (2⁸=256),

. . . , and

bit-1=LSB (2⁰=1).

Due to tolerance variation of the gain of components such as LNA 6 and VGA 11 of the SAMP, the noise level of IADC and QADC can, in practice, vary from above bit-4 to under bit-8. Under Fourier analysis, the sine (sin) component of the noise, named iADC, will be superimposed upon IADC and the cosine (cos) component of the noise, named qADC, will be superimposed upon QADC. Thus, the associated noise signal power, named NSP, is equal to:

NSP=(iADC²)+(qADC²) (1)

As the noise is a pseudo-random data steam, it takes at least a number, N, of samples to arrive at a time-averaged value of acceptable accuracy. Under the current circumstance with its typically associated statistics of the NSP, notwithstanding a minimum N of 128 is required, a conservative N of 256 is chosen for implementation. Thus, the average noise power, ANSP, is computed with the following formula:

ANSP=[(iADC² for N-samples)+(qADC² for N-samples)]/N (2)

Notice that, due to operational factors like environmental variations and component aging, etc., the above ANSP should be periodically updated during receiver idle time in addition to data collection at system power on. After arriving at the ANSP value, the next step for the CGS is to determine and set a signal power detection threshold for the preamble signal of a packet, below which a received signal power shall by definition be ignored by the WLAN receiver 60, so as to achieve an overall low enough thus acceptable system Bit Error Rate (BER) for the WLAN receiver 60. Thus, in this particular system the detection threshold for the preamble signal is set at about 10 dB above the ANSP. As a difference of 10 dB in power is equivalent to a factor of ten (10) in the linear domain, this means that the receiver signal power detection threshold is set at a value that is ten (10) times higher than the ANSP. For convenience of computing, this power detection threshold is set to correspond to a digital count of 63 equivalent to an input signal power detection threshold level of 64 counts (64=63+1) according to formula (2) above. Therefore, an initial gain, GAIN₀, of the VGA 11 is set with a gain reduction from its full gain value, GAIN_{f}, according to the following formula to insure that the VGA 11 has a total of 36 dB signal level detection during the later operation of packet signal detection and gain setting:

GAIN₀=GAIN_{f}−[10 dB+10 Log(ANSP/63)], (3a)

or equivalently:

GAIN₀=GAIN_{f}+8 dB−10 Log(ANSP) (3b)

In the above, GAIN_{f} is the value of GAIN₀ when the gain reduction of the VGA 11 is 0 dB. Of course, after the gain of the VGA 11 has been set by the CGS according to the above, the Tx/Rx switch 3 is then switched back to its normal receiving mode to resume normal operation of the WLAN receiver 60.

(B) Packet Signal Detection and Gain Setting.

In general, the output noise power of a receiver is established by the combination of its receiver noise figure (RNF, unit=dB) and gain of the receiver. Additionally, the receiver sensitivity is determined by its signal to noise ratio. Therefore, the RNF directly controls its sensitivity. The IEEE 802.11 specification requires a minimum receiver sensitivity of −82 dBm (power level based on a reference power of 1 mW, thus a power level of 0 dBm=1 mW) with a 20 MHz channel bandwidth that is equivalent to an allowed maximum RNF of 9 dB. For a sufficient design margin, the RNF is thus set at around 6 dB. Hence, the combination of a 20 MHz channel bandwidth and an RNF of 6 dB translates into an equivalent receiver input noise (RIN) to −95 dBm. As explained before, the detection threshold for the preamble signal is set at about 10 dB above the ANSP so that the WLAN receiver 60 can achieve an acceptable system BER. Hence, the minimally detectable preamble signal level required of the receiver is −85 dBm, 10 dB above the RIN of −95 dBm. As already explained above, the input signal power detection threshold level (of both of the ADC 17 and ADC 18) −85 dBm is set at 64 counts digital equivalence. The input signal power (IPSP) is, expressed in the digital domain:

IPSP=(IADC²)+(QADC²) (4)

Given an IPSP=64 counts, if any one of IADC or QADC is zero, then the other signal level should be:

Square root of 64=8=2³,

corresponding to bit-4 of the ADC. In essence, any incoming preamble IPSP below 64 counts of digital equivalence shall be ignored by the CGS while an IPSP above 64 counts shall trigger a real CGS operation in conjunction with the AGC means.

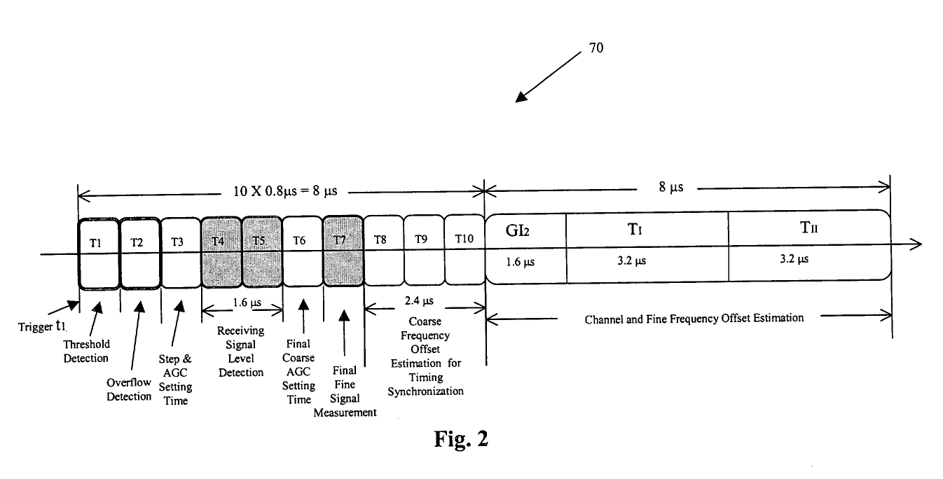

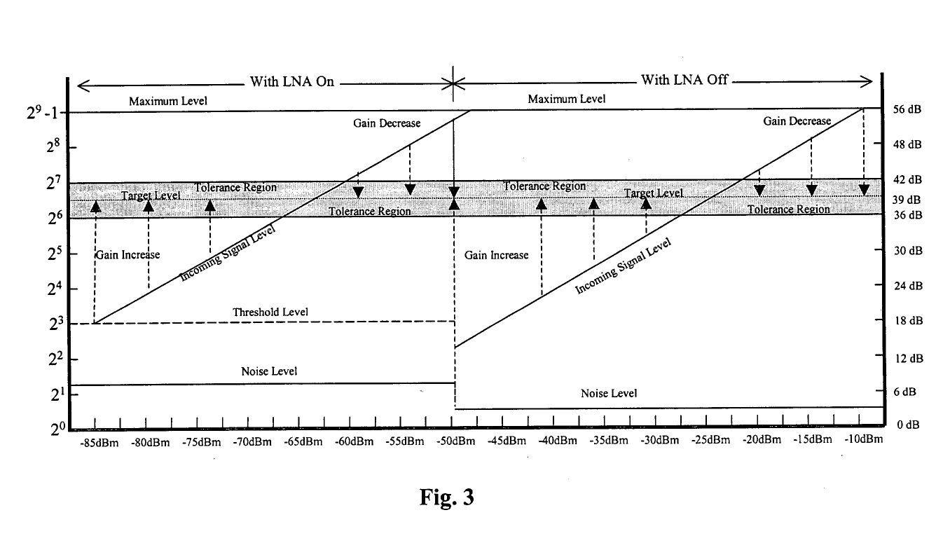

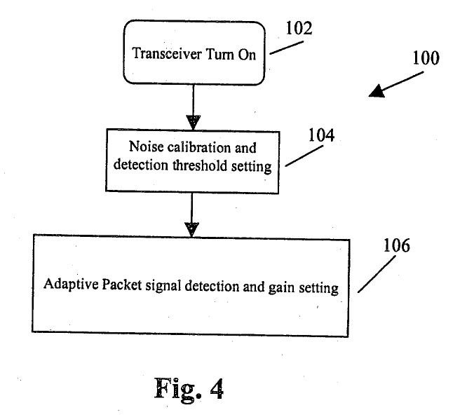

As every packet signal under IEEE 802.11 has a predetermined number of built-in identical preamble signals preceding a header and data field, the WLAN receiver 60 of the present invention takes full advantage of these preambles to establish an early good data reception of each packet prior to the occurrence of the header and data fields. Specifically, references are s made jointly to FIG. 2, FIG. 3 and FIG. 4.

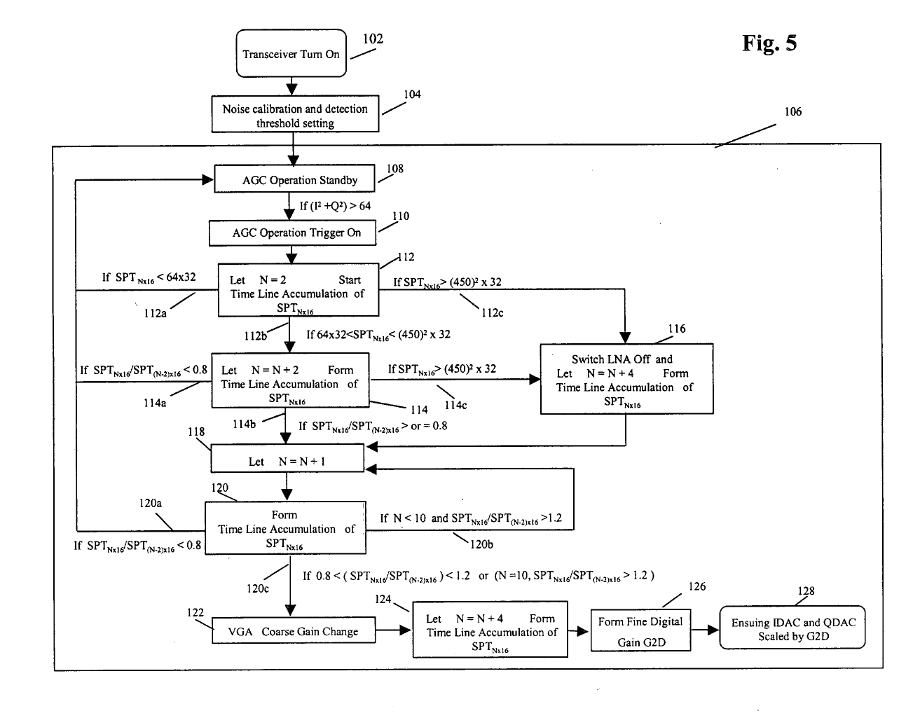

FIG. 2 shows a simplified timing diagram of a preamble 70 within a single signal packet under the IEEE 802.11 illustrating the time sequence for signal level detection and dynamic internal gain adjustment to achieve a high data exchange rate while maintaining full operational compatibility with IEEE 802.11. FIG. 3 shows a detailed quantitative diagram illustrating the operational analog signal latitude of the SAMP and a corresponding operational digital signal latitude of the CGS in cooperation with the AGC means; and FIG. 4 is a flow chart depicting the overall CGS including a an Adaptive Packet Signal Detection and Gain Setting means 106 in the digital domain that is depicted in detailed in FIG. 5.

In FIG. 4, the CGS 100 starts with a Transceiver Turn On 102 followed by a Noise Calibration and Detection Threshold Setting means 104 whose details were already described above in (A) Internal noise calibration and detection threshold setting. The Noise Calibration and Detection Threshold Setting means 104 is followed by the Adaptive Packet Signal Detection and Gain Setting means 106 whose detail, being shown in FIG. 5, will be presently described in conjunction with FIG. 2 and FIG. 3.

As shown in FIG. 2, the preamble 70 has a time window of 161s (micro second, 10⁻⁶ see) that is divided into two halves. The first half further consists of 20 small sections, T1, T2, . . . T10 each of 0.8 μs. The IEEE802.11 specification designates the three small sections, T8, T9 and T10 totaling 2.4 μs, for coarse frequency offset estimation and thus timing synchronization. The second half consists of time periods GI₂, T_{I} and T_{II} needed for channel and fine frequency offset estimation. Following the preamble 70, although not shown in FIG. 2, there is a 4 μs header signifying a data delivery rate and a corresponding total length of actual data. Thus, the Adaptive Packet Signal Detection and Gain Setting means 106 must use an agile gain control algorithm that only uses the first 7 small sections, T1-T7 totaling 5.6 μs, to perform the packet signal detection and to finish the gain setting.

The sampling rate of the ADC means 44 is driven by an ADC clock frequency. In most IEEE802.11 receivers the ADC clock frequency is 40 MHz that is equivalent to 25 nanosecond (ns, 10⁻⁹ sec) per sample. Thus, within the time of each small section, 0.8 μs, 32 data samples can be taken by each of the ADC 17 and the ADC 18. That is:

T1 consists of ADC sample times: t1, t2 . . . , t32; and

T2 consists of ADC sample times: t33, t34 . . . , t64; etc.

wherein each of T1-T7 is 0.8 μs and

each of t1, t2 . . . , t33, t34, . . . , t64, . . . is 25 ns.

This means, within T1-T7, a total of 7×32=224 data samples are available to accomplish packet signal detection and gain setting. For convenience, the following are further defined:

IPSPᵢ=(LADCₜᵢ²)+(QADCₜᵢ²) for i=1, 2, 3 . . . where IADCₜᵢ and QADCₜᵢ are respectively sampled, at time ti, digital outputs from the ADC 17 and ADC 18;

$$\begin{matrix}{SPT}_{32} = \{ {\sum }_{i = 1}^{32} {IPSP}_{i} \} ; \\ {SPT}_{33} = \{ {\sum }_{i = 2}^{33} {IPSP}_{i} \} ; \\ … ; and \\ {SPT}_{64} = \{ {\sum }_{i = 33}^{64} {IPSP}_{i} \} .\end{matrix}$$

Notice that the above SPT₃₂, SPT₃₃, . . . , SPT₆₄ are simply cumulated input signal power data across their respective time windows delimited by the index “i”. Starting with a state of AGC Operation Standby 108 (FIG. 5) of the Adaptive Packet Signal Detection and Gain Setting means (APDG) 106, an IPSP₁ greater than 64, the digital count corresponding to the power detection threshold as set before, causes an AGC Operation Trigger on 110, as signified by the associated logic condition “If (I²+Q²)>64”. The AGC Operation Trigger on 110 then starts an operation called N=2 and Start Time Line Accumulation of SPT_{N×16} 112 wherein an index N is initialized with a value of 2 and the cumulated input signal power data SPT_{N×16} is collected and computed. Notice that:

with N=2, SPT_{N×16}=SPT₃₂.

Next, if:

SPT_{N×16}<64×32 (64×32=2048) counts, or alternatively,

if SPT_{N×16}>2048 counts BUT the SPT_{N×16} has more than 4 consecutive sub-samples IPSPᵢ<16 counts

this means that the input signal power is either still below the power detection threshold of 64 or is an impulse type noise and should be ignored. Accordingly, the APDG shall cease operation by following a branch 112a back to the AGC Operation Standby 108. On the other hand, if:

SPT_{N×16}>450²×32 (450²×32=6,480,000), 35 dB above the threshold 64×32,

the input signal power level may cause a potential overflow of the ADC means 44 necessitating a branch 112c to switch off LNA 6 and start processing block N=N+4 and Form Time Line Accumulation of SPT_{N×16} 116, wherein the analog gain G1A of the SAMP will be properly reduced to avoid the ADC overflow in a manner to be presently described below. Lastly, if:

64×32 (64×32=2048)<SPT_{N×16}<450²×32(450²×32=6,480,000)

this means that the input signal power may be within a valid range but still needs more data continuity to confirm. Thus, the next operation, following a branch 112b, is a N=N+2 and Form Time Line Accumulation of SPT_{N×16} 114 wherein the index N gets incremented by 2 and a corresponding cumulated input signal power data SPT_{N×16} is collected and computed.

Notice that:

with N=4, SPT_{N×16}=SPT₆₄

and we are now located at the end of time T2 (FIG. 2). The APDG will make the following decisions:

(I) If the cumulated input signal power data SPT₆₄ is significantly less than STP₃₂, having decreased for example by more than 20% from SPT₃₂ to SPT₆₄, the input signal power data may not be a valid preamble signal. Thus, the APDG shall cease operation by following a branch 114a back to the AGC Operation Standby 108; or

(II) If the cumulated input signal power data:

SPT₆₄/STP₃₂>=0.8 and

SPT₆₄<4502×32=6,480,000

the APDG should continue to form another cumulated input signal power data SPT₉₆ by following a branch 114b to an Increment N=N+1 118 and perform a Form Time Line Accumulation of SPT_{N×16} 120; or

(III) If the cumulated input signal power data:

SPT₆₄>450²×32(450²×32=6,480,000)

the input signal power has reached a corresponding level higher than −50 dBm that starts to cause an overflow of the ADC means 44. Hence, the APDG will now switch off the LNA 6 to reduce the receiver gain by 25 dB and the APDG will also reduce the gain of the VGA 11 to further reduce the receiver gain by another 15 dB thus effecting a total gain reduction of 40 dB to avoid the overflow of the ADC means 44. Notice that, as the actions of LNA switch-off and VGA gain reduction requires a total time of about 800 ns for settlement, the APDG becomes and remains incapable of sampling data between sample times t64 and t96. However, the APDG will resume data sampling from t97 to t128 for SPT₁₂₈. These actions are signified by a branch 114c followed by an N=N+4 and Form Time Line Accumulation of SPT_{N×}16 116, the Increment N=N+1 118 and the Form Time Line Accumulation of SPT_{N×16} 120.

Following case (II) above, the APDG will continue to accumulate input signal power data till SPT₈₀ and then compare SPT₈₀ with SPT₆₄. If the difference between SPT₈₀ and SPT₆₄ is now within 20%, the APDG will move on to a VGA Coarse Gain Change 122, as will be presently described, employing the most cumulated input signal power data. An associated coarse change of the VGA 11 will execute at sample time t81 followed by a VGA gain settlement during sample times t81 and t144, etc. Notice that in the case (III) above, the Increment N=N+1 118 will cause a subsequent data accumulation of STP₁₄₄ instead of SPT₈₀.

After performing the Form Time Line Accumulation of SPT_{N×16} 120, the SPT₆₄ and the SPT₉₆ are compared again and the APDG will make the following additional decisions:

(IV) If the cumulated input signal power data SPT₉₆ is significantly less than STP₆₄, having decreased for example by more than 20% from SPT₆₄ to SPT₉₆, the input signal power data may still not be a valid preamble signal. Thus, the APDG shall cease operation by following branch 120a back to the AGC Operation Standby 108; or

(V) If the cumulated input signal power data:

SPT₉₆/SPT₆₄>1.2 and

N<10

this means that the input signal power is still increasing significantly and we are also located within a maximum allowable time limit to collect more data (N=10 corresponds to SPT_{N×16}=SPT₁₆₀ which means that we are at the end of time T5, the maximum allowable time limit to collect data). Thus, the APDG shall continue accumulating more data such as SPT₁₁₂, SPT₁₂₈, etc. This is signified by the sub-loop comprising a branch 120b, the Increment N=N+1 118 and the Form Time Line Accumulation of SPT_{N×16} 120. For example, after the collection of signal power data SPT₁₁₂, SPT₁₁₂ and SPT₉₆ are compared again and if SPT₁₁₂ is now within 20% of SPT₉₆ this means that the input signal power has stabilized and the APDG can move on through a branch 120c to a VGA Coarse Gain Change 122, to be presently described, employing the cumulated input signal power data SPT₁₁₂. On the other hand, if SPT₁₁₂ is still greater than SPT₉₆ by more than 20%, the APDG shall continue accumulating more data and compare SPT₁₂₈ to SPT₁₁₂, SPT₁₄₄ to SPT₁₂₈, and SPT₁₆₀ to SPT₁₄₄. At the end of data accumulation of SPT₁₆₀, we are at the end of time T5 (FIG. 2), 4 μs from the AGC Operation Trigger on 110 where, absent any abnormally high extraneous noise, the input signal power should have reached its stable state. At this time, the APDG must make a final decision as follows:

(Va) If the cumulated input signal power data SPT₁₆₀ is significantly less than STP₁₄₄, having decreased for example by more than 20% from SPT₁₄₄ to SPT₁₆₀, the input signal power data may still not be a valid preamble signal. Thus, the APDG shall cease operation by following branch 120a back to the AGC Operation Standby 108; or

(Vb) If the input signal power is still increasing significantly (SPT₁₆₀/SPT₁₄₄>1.2), BUT the maximum allowable time limit to collect more data has run out (N=10) or the difference between SPT₁₆₀ and SPT₁₄₄ is now within 20%, the APDG can, through branch 120c, go to the VGA Coarse Gain Change 122, to be presently described, employing the cumulated input signal power data STP₁₆₀.

Under the VGA Coarse Gain Change 122, the gain GVAR (dB) of the VGA 11 is to be adjusted within the range RVAR so that:

(SPT_{N×16})/32=a designated power level count of 90²,

where SPT_{N×16}, the employed cumulated input signal power data, can be any one of SPT₉₆, SPT ₁₁₂, . . . , SPT₁₆₀, depending upon the actual executional flow of the APDG as described above. The reason for setting the designated power level count at a lower value of 902, instead of at a calculated value of 1282 is, considering an anticipated tolerance of +/−3 dB of the nominal value of the first controllable analog gain G1A, to allow a maximum range of adjustment of the G1A while avoiding an overflow of the ADC means 44. Thus, the coarse VGA gain change to be applied by the VGA Coarse Gain Change 122 is:

coarse VGA gain change=10 log (90^{2×32}/SPT_{N×16}) (5a)

or equivalently,

VGA gain change=54 dB−10 log(SPT_{N×16}) (5b)

For an example of SPT_{N×16}=SPT₉₆, we are now at the end of time T3 of the preamble (FIG. 2). Therefore, the VGA 11 will receive an order from the CAGC 21 to change its amplifier gain at ADC sample time t97. As the VGA 11 needs a maximum time of 800 ns to change its gain while the ADC sample time period is only 25 ns, the sampling time from t65 to t96 will run out without accumulating any cumulated input signal power data at T4. Starting t97, however, the APDG can start accumulating data SPT₁₂₈ again from t97 to t128 and this is illustrated with a N=N+4 and Form Time Line Accumulation SPT_{N×16} 124 of FIG. 5. After accumulating the data SPT₁₂₈, a Form Fine Digital Gain G2D 126 will form the fine digital gain G2D using the following formula:

G2D=(1282×32)/SPT_{N×16} (6)

Notice that, in this example, the above SPT_{N×16}=SPT₁₂₈. Following the computation of the fine digital gain G2D, all the ensuing sampled packet data IADC and QADC from t129 till the end of this packet will be, as signified by the processing block 128, multiplied by G2D before final digital data recovery by the Digital Data Demodulator 25. After finishing the signal processing of a complete data packet as described, the APDG will start all over again from the AGC Operation Standby 108 for the next data packet.

To summarize, for an agile gain control on a packet-by-packet basis, the IEEE 802.11 WLAN receiver 60 needs to perform an internal noise calibration and detection threshold setting before starting the AGC operation of packet signal detection and gain setting. To achieve an acceptable BER, the incoming SNR should be at least 10 dB. Therefore, with reference made to FIG. 3, the power detection threshold is set at 10 dB above the noise and this threshold corresponds to a digital count of 64. Absent the switching action of the LNA 6, the ADC means 44 has a measurement range of from bit-3 to bit-9 covering only 36 dB and the ADC means 44 would overflow with a higher level incoming signal. When this happens, the APDG will switch off the LNA 6 to reduce the receiver gain by 25 dB and also reduce the gain of the VGA 11 by 15 dB to gain a total 40 dB more measurement range. In this way, the WLAN receiver 60 provides an overall incoming signal measurement range of 35+40=75 dB. While the specification of IEEE 802.11 requires a signal measurement range from −82 dBm to −20 dBm, the measurement range of our present invention can cover a significantly wider range, from −85 dBm to −10 dBm.

As described with an exemplary case, a WLAN receiver is described having an internal signal gain that is, responding to a wide and temporal variation of the incoming RF signal, automatically and dynamically adjustable on a packet-by-packet basis while maintaining operational compatibility with the worldwide open standard of IEEE802.11. However, for those skilled in this field, the exemplary embodiment can be easily adapted and modified to suit additional applications without departing from the spirit and scope of this invention. For example, the ADC clock frequency can be set at values other than 40 MHz as long as the AGC means can still accomplish all its tasks with adequate signal statistics within the time limit T7. For another example, the resolution of the ADCs 17 and 18 can be selected to be other than 10-bit resulting in a receiver having a correspondingly different resolution of digital data recovery for entirely different applications.

Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

1. A Wireless LAN (WLAN) Receiver with packet level Automatic Gain Control (RXAGC) for receiving and converting an incoming RF packet signal having a predetermined number of input signal preambles followed by encoded digital data, into correspondingly recovered digital data, the RXAGC comprising:
an antenna for receiving the incoming RF packet signal and transmitting an outgoing RF packet signal there from;
a Switchable Coupling means (SCP) coupled to said antenna for switchably coupling said incoming RF packet signal through said antenna;
an analog signal processing means (ASP) coupled to said SCP for conditioning and converting said incoming RF packet signal into, under a first controllable analog gain G1A (dB), phase-separated video signals VSI and VSQ;
an Analog to Digital Converter (ADC) means, serially coupled to said ASP, for converting said video signals VSI and VSQ respectively into two digital outputs IADC and QADC;
an Automatic Gain Control (AGC) means, serially coupled to the output of said ADC means and controllingly coupled to said SCP and said ASP thus capable of effecting a corresponding adjustment of said first controllable analog gain G1A, for digitally scaling, under a second controllable fine digital gain G2D (dB), said digital outputs IADC and QADC into a final set of digital signals DSI and DSQ before sending them for recovery into digital data by a subsequent digital data demodulator, and
whereby said AGC means further comprising a Calibration and Gain Setting means (CGS) capable of dynamically measuring said preamble signals of each incoming RF packet signal and responsively adjusting both said G1A and said G2D such that the RXAGC exhibits a dynamically adjustable overall system signal amplification of G1A+G2D (dB), between said incoming RF packet signal and each of said digital signals DSI and DSQ, responsive to any RF packet signal variations on a packet-by-packet basis

2. The RXAGC of claim 1 wherein said ASP further comprises a Signal Amplifying means (SAMP) providing to said first controllable analog gain G1A.

3. The RXAGC of claim 2 wherein said SAMP further comprises a bypassable Low Noise Amplifier (LNA)with a fixed gain of GFXD (dB) thus effecting a correspondingly quantized component adjustment of said GIA by an amount GFXD under the control of said AGC means.

4. The RXAGC of claim 3 wherein said SAMP further comprises a serially coupled Variable Gain Amplifier (VGA) with a gain of GVAR (dB) having an adjustable range of RVAR (dB) under the control of said AGC means, where G1A=GFXD+GVAR, thus effecting an additional corresponding continuous adjustment of said G1A with a range of GVAR.

5. The RXAGC of claim 4 wherein said AGC means further comprises a coarse AGC means (CAGC) for causing a corresponding coarse adjustment of said G1A through at least one of the following actions: (a) changing the bypassing state of said LNA; and (b) adjusting the gain GVAR of said VGA.

6. The RXAGC of claim 5 wherein said AGC means further comprises a Fine AGC means (FAGC) for causing a corresponding fine adjustment of said second controllable fine digital gain G2D by digitally scaling, with an equivalent controllable digital gain of G2D, said digital outputs IADC and QADC into the final set of digital signals DSI and DSQ before recovery into digital data by said digital data demodulator.

7. The RXAGC of claim 6 wherein said CGS further comprises a Noise Calibration and Detection Threshold Setting means (NCDT) for calibrating an inherent noise, named an average noise signal power (ANSP), and setting up a corresponding signal power detection threshold below which a received preamble signal power shall be ignored so as to achieve an overall low system Bit Error Rate (BER) for the RXAGC.

8. The RXAGC of claim 7 wherein said signal power detection threshold is set at, at least, about 10 dB above said ANSP.

9. The RXAGC of claim 7 wherein the function of said NCDT is performed at system power on of the RXAGC.

10. The RXAGC of claim 9 wherein the function of said NCDT is further performed periodically during idle time of the RXAGC.

11. The RXAGC of claim 7 wherein said CGS further comprises an Adaptive Packet Signal Detection and Gain Setting means (APDG) for adaptively sampling each RF packet signal preamble, computing a corresponding preamble signal power level and correspondingly adjusting said overall system signal amplification of G1A+G2D within the same packet to achieve a high data reception rate regardless of the wide and temporal signal variations of the incoming RF packets.

12. The RXAGC of claim 11 wherein said APDG further comprises a means for, while sampling each RF packet signal preamble for a cumulated input signal power data, detecting and ignoring undesirable signal dynamics of each RF packet signal preamble when the power level of said RF packet signal preamble is still below said power detection threshold.

13. The RXAGC of claim 12 wherein said means for detecting and ignoring said undesirable signal dynamics of each RF packet signal preamble further comprises detecting and ignoring excessively large signal transitions for said cumulated input signal power data.

14. The RXAGC of claim 12 wherein said means for detecting and ignoring said undesirable signal dynamics of each RF packet signal preamble further comprises detecting valid yet unsettling cumulated input signal power data for ordering more data sampling to confirm its stability.

15. The RXAGC of claim 12 wherein said means for detecting and ignoring said undesirable signal dynamics of each RF packet signal preamble further comprises detecting said cumulated input signal power data that exceeds a pre-determined level to promp a momentary halt of the RF packet signal preamble sampling process while said APDG correspondingly reduces said overall system signal amplification of G1A+G2D to avoid the overflow of said ADC.

16. The RXAGC of claim 12 wherein said means for detecting and ignoring said undesirable signal dynamics of each RF packet signal preamble further comprises computing the corresponding preamble signal power level and to adjust said overall system signal amplification of G1A+G2D within the same packet before adopting the ensuing cumulated input signal power data.

17. The RXAGC of claim 12 wherein said ASP further comprises a Frequency Downward Conversion means (FDC) distributedly and serially coupled to said SAMP for successively down-converting said incoming RF packet signal into an Intermediate Frequency (IF) signal then further into two phase-separated component video signals respectively named in-phase video I and quadrature-phase video Q.

18. The RXAGC of claim 13 wherein said ASP further comprises a Frequency Bandpass Filtering means (FBF) distributedly and serially coupled to said SAMP and said FDC for allowing the passing through of a desired channel signal of said incoming RF packet signal while rejecting all other off-band signal frequencies.

19. The RXAGC of claim 18 wherein said incoming RF packet signal conforms to an industry standard specification of IEEE 802.11, thus said input signal preambles having a total of twenty (20) small signal sections, and wherein said CGS takes less than eight (8) small signal sections to accomplish the task of dynamically measuring said preamble signals of each incoming RF packet signal and responsively adjusting both said G1A and said G2D.

20. A method for designing a Wireless LAN (WLAN) Receiver with packet level Automatic Gain Control (RXAGC) for receiving and converting an incoming RF packet signal having a predetermined number of input signal preambles followed by encoded digital data, into correspondingly recovered digital data, the RXAGC comprising the steps of:
providing an antenna for receiving the incoming RF packet signal and transmitting an outgoing RF packet signal there from;
coupling a Switchable Coupling means (SCP) to said antenna for switchably coupling said incoming RF packet signal through said antenna;
coupling an analog signal processing means (ASP) to said SCP for conditioning and converting said incoming RF packet signal into, under a first controllable analog gain G1A (dB), phase-separated video signals VSI and VSQ;
providing an Analog to Digital Converter (ADC) means, serially coupled to said ASP, for converting said video signals VSI and VSQ respectively into two digital outputs IADC and QADC;
providing an Automatic Gain Control (AGC) means, serially coupled to the output of said ADC means and controllingly coupled to said SCP and said ASP thus capable of effecting a corresponding adjustment of said first controllable analog gain GIA, for digitally scaling, under a second controllable fine digital gain G2D (dB), said digital outputs IADC and QADC into a final set of digital signals DSI and DSQ before sending them for recovery into digital data by a subsequent digital data demodulator, and
whereby said AGC means further comprising a step of providing a Calibration and Gain Setting means (CGS) capable of dynamically measuring said preamble signals of each incoming RF packet signal and responsively adjusting both said G1A and said G2D such that the RXAGC exhibits a dynamically adjustable overall system signal amplification of G1A+G2D (dB), between said incoming RF packet signal and each of said digital signals DSI and DSQ, responsive to any RF packet signal variations on a packet-by-packet basis

21. The method of claim 20 wherein said ASP further comprises a step of providing a Signal Amplifying means (SAMP) to said first controllable analog gain G1A.

22. The method of claim 21 wherein said SAMP further comprises providing a bypassable Low Noise Amplifier (LNA) with a fixed gain of GFXD (dB) thus effecting a correspondingly quantized component adjustment of said G1A by an amount GFXD under the control of said AGC means.

23. The method of claim 22 wherein said SAMP further comprises the step of serially coupling a Variable Gain Amplifier (VGA) with a gain of GVAR (dB) having an adjustable range of RVAR (dB) under the control of said AGC means, where G1A=GFXD+GVAR, thus effecting an additional corresponding continuous adjustment of said G1A with a range of GVAR.

24. The method of claim 23 wherein said AGC means further comprises a coarse AGC means (CAGC) for causing a corresponding coarse adjustment of said G1A through at least one of the following actions: (a) changing the bypassing state of said LNA; and (b) adjusting the gain GVAR of said VGA.

25. The method of claim 24 wherein said AGC means further comprises a Fine AGC means (FAGC) for causing a corresponding fine adjustment of said second controllable fine digital gain G2D by digitally scaling, with an equivalent controllable digital gain of G2D, said digital outputs LADC and QADC into the final set of digital signals DSI and DSQ before recovery into digital data by said digital data demodulator.

26. The method of claim 25 further comprises a step of providing a Noise Calibration and Detection Threshold Setting means (NCDT) to said CGS for calibrating an inherent noise, named an average noise signal power (ANSP), and setting up a corresponding signal power detection threshold below which a received preamble signal power shall be ignored so as to achieve an overall low system Bit Error Rate (BER) for the RXAGC.

27. The method of claim 26 wherein said signal power detection threshold is set at, at least, about 10 dB above said ANSP.

28. The method of claim 27 wherein the function of said NCDT is performed at system power on of the RXAGC.

29. The method of claim 28 wherein the function of said NCDT is further performed periodically during idle time of the RXAGC.

30. The method of claim 26 further comprises a step of providing an Adaptive Packet Signal Detection and Gain Setting means (APDG) to said CGS for adaptively sampling each RF packet signal preamble, computing a corresponding preamble signal power level and correspondingly adjusting said overall system signal amplification of G1A+G2D within the same packet to achieve a high data reception rate regardless of the wide and temporal signal variations of the incoming RF packets.

31. The method of claim 30 wherein said APDG further comprises a means for, while sampling each RF packet signal preamble for a cumulated input signal power data, detecting and ignoring undesirable signal dynamics of each RF packet signal preamble when the power level of said RF packet signal preamble is still below said power detection threshold.

32. The method of claim 31 wherein said means for detecting and ignoring said undesirable signal dynamics of each RF packet signal preamble further comprises a step of detecting and ignoring excessively large signal transitions for said cumulated input signal power data.

33. The method of claim 31 wherein said means for detecting and ignoring said undesirable signal dynamics of each RF packet signal preamble further comprises a step of detecting valid yet unsettling cumulated input signal power data for ordering more data sampling to confirm its stability.

34. The method of claim 31 wherein said means for detecting and ignoring said undesirable signal dynamics of each RF packet signal preamble further comprises a step of detecting said cumulated input signal power data that exceeds a predetermined level to prompt a momentary halt of the RF packet signal preamble sampling process while said APDG correspondingly reduces said overall system signal amplification of G1A+G2D to avoid the overflow of said ADC.

35. The method of claim 31 wherein said means for detecting and ignoring said undesirable signal dynamics of each RF packet signal preamble further comprises a step of computing the corresponding preamble signal power level and to adjust said overall system signal amplification of G1A+G2D within the same packet before adopting the ensuing cumulated input signal power data.

36. The method of claim 31 wherein said ASP further comprises a Frequency Downward Conversion means (FDC) distributedly and serially coupled to said SAMP for successively down-converting said incoming RF packet signal into an Intermediate Frequency (IF) signal then further into two phase-separated component video signals respectively named in-phase video I and quadrature-phase video Q.

37. The method of claim 31 wherein said ASP further comprises a Frequency Bandpass Filtering means (FBF) distributedly and serially coupled to said SAMP and said FDC for allowing the passing through of a desired channel signal of said incoming RF packet signal while rejecting all other off-band signal frequencies.

38. The method of claim 37 wherein said incoming RF packet signal conforms to an industry standard specification of IEEE 802.11, thus said input signal preambles having a total of twenty (20) small signal sections, and wherein said CGS takes less than eight (8) small signal sections to accomplish the task of dynamically measuring said preamble signals of each incoming RF packet signal and responsively adjusting both said G1A and said G2D.
